(19) United States
(12) Patent Application Publication
(10) Pub. No.: US 2016/0063655 A1
(43) Pub. Date: Mar. 3, 2016

(54) SYSTEMS AND METHODS FOR OPTIMIZING QUEUING WEB-BASED LIVE TUTORING

(71) Applicant: Think Through Learning, Inc., Pittsburgh, PA (US)

(72) Inventors: Louis PICONI, Pittsburgh, PA (US); Timothy BICKERTON, Pittsburgh, PA (US); Matthew MACHUGA, Waterford, PA (US); Keith WEIGHTMAN, Pittsburgh, PA (US); James WRUBEL, Cranberry Township, PA (US)

(21) Appl. No.: 14/707,497

(22) Filed: May 8, 2015

Related U.S. Application Data
(60) Provisional application No. 62/043,755, filed on Aug. 29, 2014.

(51) Int. Cl. G06Q 50/20; H04L 12/863

(52) U.S. Cl. CPC G06Q 50/20; H04L 47/623; H04L 47/6245

(57) ABSTRACT

A method and system for optimizing queuing in web-based live tutoring is described. A request for live support is received from at least one first user and the first user is placed in a queue. A plurality of parameters are determined for the first user. The queue is then optimized by iteratively assigning and updating a queue priority level for the first user, wherein the queue priority level indicates a location in the queue at which the first user is currently placed. If the first user is at the front of the queue, at least one second user such as an available teacher or tutor is matched to the first user. Conversely, if the first user is not at the front of the queue, the queue priority level for the first user is updated accordingly.

### CLAIM OF PRIORITY AND RELATED APPLICATION

This patent application claims priority to U.S. Provisional Patent No. 62/043,755, entitled “Systems and Methods for Optimizing Queuing Web-Based Live Tutoring,” filed on Aug. 29, 2014, the content of which is hereby incorporated by reference in its entirety.

### BACKGROUND

With the proliferation of the Internet, users from around the world can instantly connect to each other for a wide variety of reasons. For example, students may remotely connect with teachers or tutors for web-based teaching or tutoring, particularly for online courses, testing, instruction, and/or the like. A student may request a teacher's assistance in completing a task, learning a lesson, answering a test question, and/or the like. In some instances, there may be more students than teachers in a web-based learning scenario. Accordingly, students may have to wait for a teacher to become available before receiving assistance.

Some systems for remotely connecting a student and a teacher include placement of a student requesting help in a queue until a teacher becomes available. Such a queue may operate on a first-in, first-out (FIFO) basis whereupon users are placed in the queue based on the time an individual user requested help. Thus, a user requesting help at an earlier time is placed in the queue before all users requesting help at later times. Accordingly, users who have been waiting in the queue the longest are served first, thereby allowing the next users in the queue to move up in priority. The queue continues to add users as they request help and removes users as help is provided, or the user drops out of the queue for another reason, according to the same FIFO basis until all users in the queue have received help.

Such structured queuing systems fail to provide prioritization and, as such, may not be desirable in certain situations. For example, some students may have specific needs and/or may not have time to wait in a queue. More specifically, a student requesting help with respect to an examination on the Spanish language would not benefit from the FIFO queuing process when the teacher that is available at the time the student is at the front of the queue is a math teacher. Moreover, students taking a timed test who need immediate teacher assistance may not receive such assistance in time to complete the timed test if the queue (and thus the wait time) is long.

### SUMMARY OF THE INVENTION

In an embodiment, a method for optimizing queuing in web-based live tutoring is described. The method may include receiving a request for live support from at least one first user; placing the at least one first user in a queue; determining a plurality of parameters for the at least one first user; optimizing the queue, wherein the optimizing comprises iteratively assigning and updating a queue priority level for the at least one first user, wherein the queue priority level indicates a location in the queue at which the at least one first user is currently placed; if the at least one first user is at the front of the queue, matching at least one second user to the at least one first user; and if the at least one first user is not at the front of the queue, updating the queue priority level for the at least one first user.

In an alternative embodiment, a system for optimizing queuing in web-based live tutoring is described. The system includes a processing device and a non-transitory, computer-readable storage medium in operable communication with the processing device. The non-transitory, computer-readable storage medium includes one or more programming instructions that, when executed, cause the processing device to receive a request for live support from at least one first user; place the at least one first user in a queue; determine a plurality of parameters for the at least one first user; optimize the queue, wherein the optimizing comprises iteratively assigning and updating a queue priority level for the at least one first user, wherein the queue priority level indicates a location in the queue at which the at least one first user is currently placed; if the at least one first user is at the front of the queue, match at least one second user to the at least one first user; and if the at least one first user is not at the front of the queue, update the queue priority level for the at least one first user.

### BRIEF DESCRIPTION OF THE FIGURES

FIG. 1 depicts a block diagram of an illustrative system for connecting one or more users to an application interface and/or a database according to an embodiment.

FIG. 2 depicts a flow diagram of an illustrative method of connecting a user to a teacher according to an embodiment.

FIG. 3 depicts a flow diagram of an illustrative method of optimizing a queue of users according to an embodiment.

FIG. 4 depicts a block diagram of illustrative internal hardware that may be used to contain or implement program instructions according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

An “electronic device” refers to a device that includes a processing device and a tangible, computer-readable memory or storage device. The memory may contain programming instructions that, when executed by the processing device, cause the processing device to perform one or more operations. Examples of electronic devices include personal computers, supercomputers, gaming systems, televisions, mobile devices, medical devices, recording devices, and/or the like.

A “mobile device” refers to an electronic device that is generally portable in size and nature, or is capable of being operated while in transport. Accordingly, a user may transport a mobile device with relative ease. Examples of mobile devices include pagers, cellular phones, feature phones, smartphones, personal digital assistants (PDAs), cameras, tablet computers, phone-tablet hybrid devices (“phablets”), laptop computers, netbooks, ultrabooks, global positioning satellite (GPS) navigation devices, in-dash automotive components, media players, watches, portable medical devices, and the like.

A “computing device” is an electronic device, such as a computer, a processing device, a memory, and/or any other component, device, or system that performs one or more operations according to one or more programming instructions.

A “user” is generally any user of an electronic device, such as a user of a mobile device or a user of a computing device. Thus, the user may be an individual receiving assistance, an individual providing assistance, an administrator, and/or the like. An individual receiving assistance may generally be a user that requests assistance according to various embodiments described herein. An individual providing assistance may be a teacher, a tutor, and/or the like that provides assistance to the user requesting assistance according to various embodiments described herein. An administrator may be any individual that accesses various systems described herein to provide, maintain, and/or update an application environment, troubleshoot, provide technical support to other users, retrieve data, provide data, and/or the like.

The present disclosure relates generally to systems and methods that provide a more effective method of queuing users that request assistance from other users based on various parameters, thereby providing for prioritized ordering of a queue according to such parameters. For example, the parameters may include, but are not limited to, the type of assistance needed by the requesting user, the grade level of the requesting user, the amount of time the requesting user has spent in the queue, any special needs of the requesting user, and the expertise of an available user providing assistance. Such systems and methods may generally be effective in efficiently managing a queue and helping to ensure that a requesting user is effectively paired with a user providing assistance.

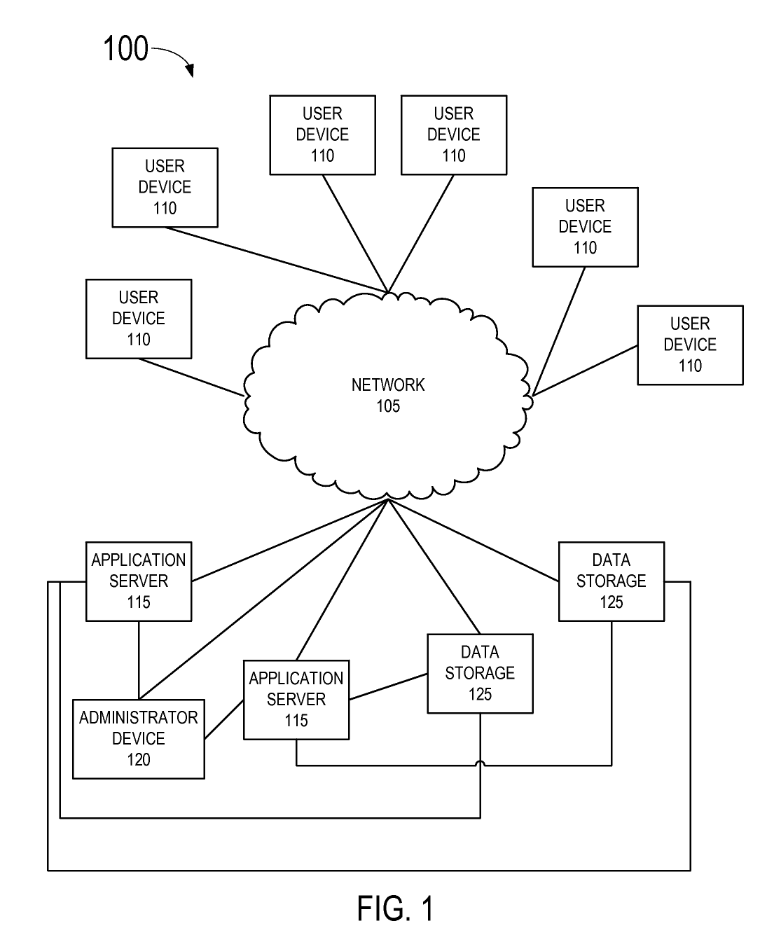

FIG. 1 depicts a block diagram of an illustrative system, generally designated 100, for providing an interface to a plurality of users according to an embodiment. The system may generally include a plurality of user devices 110 connected via a network 105. Thus, each of the various user devices 110 may be interconnected with one or more networking devices and may use any networking protocol now known or later developed. For example, the user devices 110 may be interconnected via the Internet, an intranet, a wide area network, a metropolitan area network, a local area network, a campus area network, a virtual private network, a personal network, and/or the like. The network 105 may include a wired network or a wireless network. Those having ordinary skill in the art will recognize various wired and wireless technologies that may be used for the network 105 without departing from the scope of the present disclosure.

In various embodiments, the network 105 may allow the plurality of user devices 110 to connect to one or more of an application server 115, an administrator device 120, and a data storage device 125. Additional or fewer devices may also connect to the plurality of user devices 110 via the network 105 without departing from the scope of this disclosure. For example, in some embodiments, the network 105 may permit access to one or more external databases.

In various embodiments, each user device 110 may generally provide a connection for at least one user to the network 105 and/or another user (via another user device). Thus, a user device 110 may be any type of electronic device, computing device, mobile device, and/or the like. In some embodiments, each user device 110 may be configured for the particular user that uses the device.

For example, a user device 110 may be configured to provide a user such as a student with educational curriculum, a learning module, a test taking module, a research module, and/or the like. In another example, a user device 110 may be configured to provide a user such as a teacher or tutor with educational curriculum, a research module, a remote control module, a teaching module, and/or the like. Such configurations of a user device 110 may be provided via one or more software applications, web-based applications, hardware, and/or the like. In some embodiments, a user device 110 may be configured to provide an interface from an application server 115, such as the communication interface as described in greater detail below.

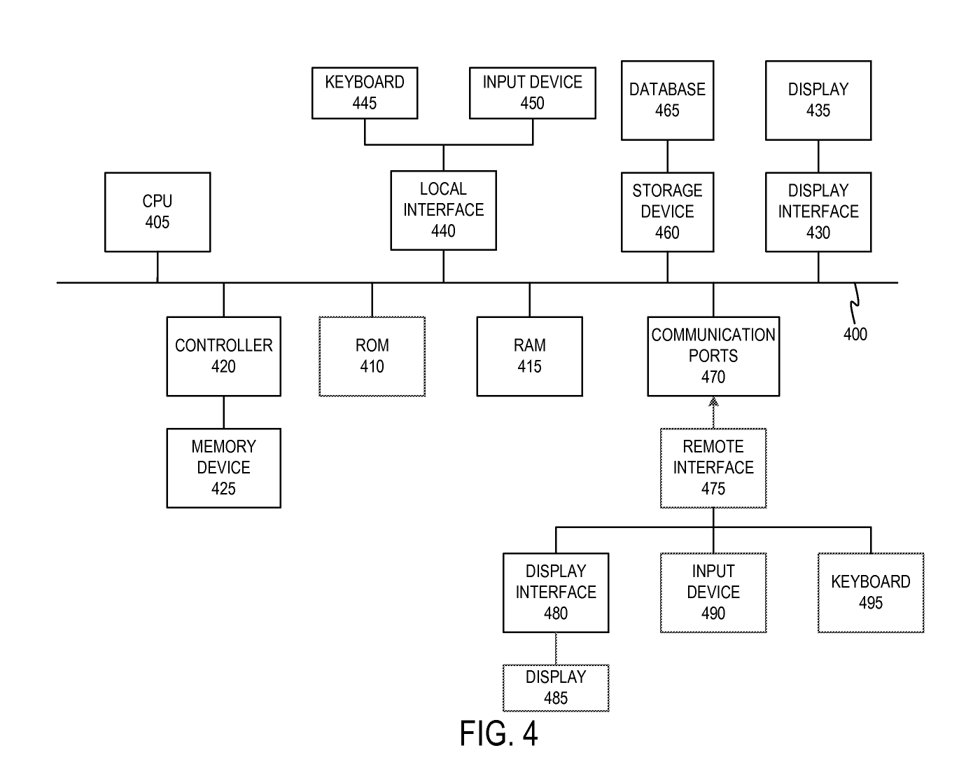

In another example, if a user device 110 is a smartphone, the user may use a smartphone application (“app”) to complete various tasks, as described in greater detail herein. A software application, web-based application, and/or the like may be configured to use various hardware portions of a user device 110, such as, for example, a camera, an input device, a sensor, and/or the like. Accordingly, the user device 110 may generally contain any hardware necessary for carrying out at least the various processes described herein. Illustrative hardware is described herein with respect to FIG. 4.

In various embodiments, the user device 110 may be configured to receive information from a user. In some embodiments, the user device 110 may be configured to provide information to a user. Illustrative information may include, but is not limited to, login information such as user ID and/or password information for use in identifying a user associated with a user device 110 and any associated account or personal data for that user, educational information, research information, queue information, student information, teacher information, and/or the like.

In various embodiments, the user device 110 may be configured to communicate with one or more other devices, such as, for example, other user devices, the application server 115, an administrator device 120, and/or a data storage device 125. Communication between the user device 110 and one or more of the other devices may generally be completed via the network 105. Such inter-device communication may include, but is not limited to, email messages, text messages, voicemail messages or other similar audio based messages, video messages such as a short video or a video chat session, and other similar messaging types.

In some embodiments, a first user device 110 may communicate with one or more second user devices when a user of the first user device receives assistance from the user of a second user device, as described in greater detail herein. In some embodiments, a user device 110 may communicate with an application server 115 to transmit software application information, as described in greater detail herein. In some embodiments, a user device 110 may communicate with an administrator device 120 for the purposes of transmitting administrative and/or technical data, as described in greater detail herein. In some embodiments, a user device 110 may communicate with a data storage device 125 to transmit data, as described in greater detail herein.

An application server 115 may generally provide one or more applications, modules, and/or the like to a user at a specific user device 110 via the network 105. For example, an application server 115 may contain a memory having one or more programming instructions that cause a processing device associated with the application server to provide the one or more applications, modules, and/or the like to a user device 110. In some embodiments, an application server 115 may be configured to provide a learning application or module to a student user at a user device 110. In some embodiments, an application server 115 may be configured to provide a teaching application or module to a teacher or tutor user at a user device 110. In some embodiments, an application server 115 may be configured to provide a research application or module.

The administrator device 120 may generally be an electronic device for use by a network or system administrator having device access and privileges above a typical system user. For example, a network administrator may use the administrator device 120 to maintain an application server 115, to communicate with users, to perform administrative functions, to retrieve administrative data, and/or the like. In some embodiments, the administrator device 120 may be essentially similar to a user device 110, but have administrator privileges not provided to the user device. In some embodiments, the administrator device 120 may connect directly to other devices such as an application server 115. In other embodiments, the administrator device 120 may connect to other devices via the network 105.

A data storage device 125 may generally store data that may be used for one or more of the functions described herein. For example, student and teacher account data from a data storage device 125 may be used to match a student with a teacher when the student requests assistance and is placed in the queue. In addition, data used for various modules, such as teaching modules, research modules, and/or the like may be stored in a data storage device 125. Accordingly, a data storage device 125 may be any electronic device that is configured to store data. Illustrative data storage devices may include, but are not limited to, hard disk drives, removable storage drives, flash memory devices, data servers, cloud-based storage solutions, and/or the like. In some embodiments, a data storage device 125 may be a portion of an application server 115 or directly connected to the application server. In other embodiments, a data storage device 125 may be a standalone device that is separate from a user device 110 and an application server 115. For example, in some embodiments, a data storage device 125 may be located at an offsite facility, and an application server 115 may be located at an administrator facility.

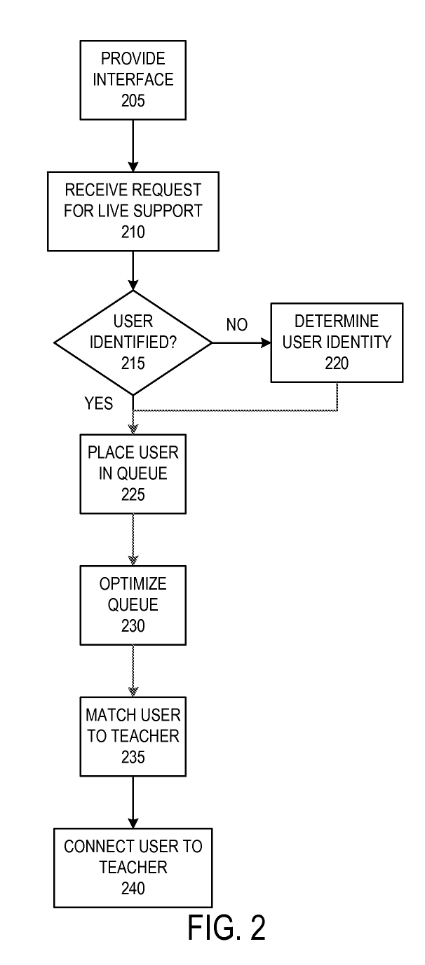

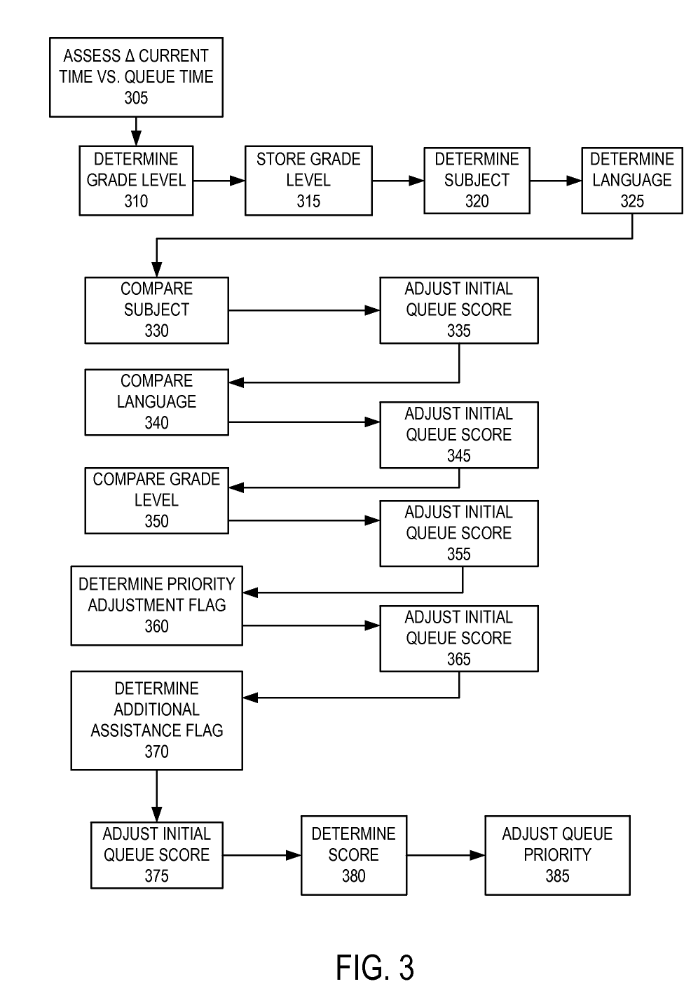

One or more of the devices described with respect to FIG. 1 may be used, either alone or in combination, to carry out one or more processes described with respect to FIGS. 2 and 3. FIG. 2 depicts an illustrative flow diagram of a general process of connecting a user requesting assistance (such as a student) to a user providing assistance (such as a teacher or tutor) according to an embodiment. FIG. 3 depicts an illustrative flow diagram of a method of optimizing a queue according to an embodiment. It should be noted that a student-teacher assistance system, method and process is shown and described herein by way of example only, and the systems, methods and processes as described herein may be applied to any system where multiple users may potentially request assistance from another user.

As shown in FIG. 2, a system, such as an application server 115 as shown in FIG. 1, may provide 205 an interface to each user that accesses the communication system. For example, the system may provide 205 a learning interface to a student user. The interface may generally provide an electronic means for a user to interact with the various applications, modules, and/or the like. For example, the interface may provide a student user with electronic means to receive electronic lessons, coursework, tests/quizzes, and/or the like. The system may receive 210 a request for live support from a user via the provided interface. The request may be made, for example, by a student user who needs assistance with completing an educational task, such as when the student user does not understand a particular topic, needs assistance in answering a question or solving a problem, needs additional explanation, and/or the like. A user may make the request by clicking on a link or other similar input area provided within the interface, voicing a request, completing a request gesture, and/or the like.

Once the system receives 210 the request, the system may determine 215 whether the user making the request has been identified. A user may generally be identified if the system is aware of the identity of the user requesting live support and has sufficient background information regarding the user. For example, the user may be identified if he/she is logged into the system via a username and/or password and/or has answered background questions. More specifically, a user may be required to provide background information such as a grade level, a language preference, a topic/subject, and/or the like. Alternatively or additionally, if the user has previously logged into the system, such information may be stored and associated with the user's account at a storage device, such as data storage 125 as shown in FIG. 1.

If the user has not been identified, such as a user who is not logged in, logged in as a guest, has not answered background questions, and/or the like, the system may determine 220 the user's identity. Such a determination 220 may include, for example, requesting that a user reply to one or more queries or providing other personal information before he/she can proceed. In some embodiments, the system may determine 220 the user based upon the subject matter he/she is interacting with. Thus, for example, if the user is interacting with an English learning module that is 5^{th} grade math, the system may determine 220 that the user is a 5^{th} grader in need of assistance with math from an English-speaking teacher or tutor that is qualified to provide assistance to a 5^{th} grader, preferably in math.

Once the system has identified the user, the system may place 225 the user in a queue. The queue may generally include all users that have requested assistance and have been identified by the system but that have not yet received any assistance. As additional users request assistance, the system may place 225 the additional users in the queue. The queue may be arranged such that the top (or front) of the queue includes the highest priority users that will be matched first. Conversely, the bottom (or back) of the queue includes the lowest priority users that will be matched last. Users may move up and down (or front and back) in the queue as their priority changes based on other users in the queue, time in the queue, language preference, grade level, subject, teacher or tutor availability, and/or the like, as described in greater detail herein.

As the system places 225 each user in the queue, the system may optimize 230 the queue to adjust each user's position, as described in greater detail herein. Once a requesting user reaches the top (or front) of the queue, and a user that provides assistance is available, the system may match 235 the two users. For example, the system may match 235 a student requesting help with a math problem with an available math teacher or tutor once the student has reached the top (or front) of the queue. Once the system has matched 235 the users, the system may connect 240 the users to each other when, for example, the assisting user pulls the requesting user from the queue.

Alternatively or additionally, the system may not be able to properly identify 220 all associated parameters for a specific user. For example, the user may want to remain anonymous or may be accessing the system as a guest. In such a case, the system may place 225 the user in the queue. However, because fewer parameters may be associated with such a user, the user's priority in the queue may not change much, if at all, during the time that the user is in the queue, other than to be updated solely as a function of the time spent in the queue. Thus, the user may be required to wait until the system matches 235 all other users with a higher initial priority.

In various embodiments, the system may connect 240 the users to each other via a joint communications interface such as a text-based chat session, a video-based chat session, a voice-based session, a telephone call, and/or the like. Such a communications interface may be determined based upon one or more parameters associated with either the requesting user or the assisting user. For example, one or both of the users may have a physical limitation such as being deaf. In such an instance, the system may default to a text-based chat session or, if the system can determine both users are knowledgeable in sign language, the system may provide a video-based chat session. Thus, such a system may satisfy various governmental statutes regarding physically disabled users and the level of service that is to be provided to such users.

In various embodiments, the system may optimize the queue each time a user is placed in the queue. Alternatively or additionally, the system may optimize the queue after an elapsed period of time or as a user is removed from the queue.

FIG. 3 depicts an example of an optimization process for each user in the queue. For each user, the system may assess 305 a timestamp representing the current time versus a timestamp representing the time when the student entered the queue. Thus, in some embodiments, the difference between the two timestamps may represent the student's current queue time.

To ensure proper placement in the queue, the system may assess one or more variables to update a queued user's priority and to help ensure a proper match between a user requesting assistance (e.g., a student) and a user providing assistance (e.g., a teacher or tutor). In various embodiments the system may determine 310 a grade level for a student user and store 315 the grade level as a number associated with a parameter for that user indicating the grade. Thus, the system may store 315 parameters for a student in 5^{th} grade including an associated number 5 to indicate the grade.

The system may determine 310 the grade level to ensure appropriate matches between users. However, based upon the programming and acceptable variations provided within the system, there may be acceptable ranges or grade differences between the user requesting assistance and the user providing the assistance. For example, it may not be appropriate to match a 12^{th} grade teacher with a 1^{st} grade student. However, a 3^{rd} grade teacher may be an appropriate match with a 1^{st} grade student. Thus, teachers (or other users providing assistance) may generally include an appropriate grade level range that they are able to teach to ensure proper matching. For example, a certain teacher may be able to teach any student from 5^{th} grade to 8^{th} grade.

In addition to grade level, the system may also determine 320 a subject the user requesting assistance is currently studying or otherwise engaged in. The subject is not limited by this disclosure and may generally be any subject. Illustrative subjects may include, but are not limited to, mathematics, languages, reading, sciences, civics, and/or the like. Subjects may generally be broad or narrow in scope. For example, mathematics subjects may also include more specific subjects such as algebra, geometry, calculus, or the like. In another example, physics subjects may also include more specific subjects such as computational physics, molecular physics, quantum mechanics, photonics, and/or the like. Similar to the grade level range, each teacher user may provide a profile of topics they are qualified to teach.

The system may also determine 325 a primary language preference associated with the user requesting assistance. The system may make such a language determination 325 to help ensure that any matched users are able to speak or otherwise communicate in a common language. For example, if a requesting user only speaks Spanish, they would not be matched with an assisting user that only speaks Romanian.

For each available teacher (or user logged in to the system and available to provide assistance), the system may compare 330 the subject associated with the user requesting assistance and the subject(s) associated with available teachers to determine whether an available teacher is qualified to teach the particular subject in need based on the teacher's profile, as described herein, and the associated subject matter of the requesting user. Based upon the result of the comparison 330, the system may adjust 335 an initial queue score related to the subject accordingly for the student. If the teacher is not qualified to teach the particular subject and the student's overall priority does not indicate that they should be matched with any available teacher, the student's initial queue score may remain unchanged. Alternatively, if the teacher is qualified to teach the subject of the requesting student or if the student has been in the queue for an extended period of time, the student's associated initial queue score may be updated accordingly. Thus, students for whom available teachers are an immediate subject match are scored higher in the initial queue score. Similarly, the longer a student waits in the queue before being matched with a teacher, the higher the student scores for teachers that are not a subject match, thereby reducing the chances that a student will sit in the queue for an unreasonable period of time without receiving some assistance.

For example, the system may include 25 teachers who are mathematics teachers, 25 teachers who are reading teachers, 25 teachers who are chemistry teachers, and 25 teachers who are physics teachers. When a student whose associated subject is mathematics joins the queue, the student would score highest (the queue priority) for the mathematics teachers. As the student's wait time increases, the student becomes a higher match for all teachers, and thus is more likely to be scored higher for a subject match. Accordingly, the end result is that students receive the best match for them while at the same time minimizing the student's wait time in the queue. Thus, in an embodiment, the system may have a set end time (e.g., 10 minutes) after which, regardless of subject, the student is matched with the next available teacher.

The system may further compare 340 whether an available teacher speaks the same language(s) as the requesting user. Based upon the result of the comparison 340, the system may adjust 345 an initial queue score related to language accordingly for the student. To continue the above example, the system may include 10 teachers who have a primary language of Spanish and 90 teachers with English as primary language. When a student whose primary language is Spanish joins the queue, the student would score highest (in initial queue scoring for language) for the Spanish teachers. As the student's wait time increases, the student becomes a higher match for all teachers, and thus is more likely to have a higher language score and to be picked up from the queue.

The system may also compare 350 whether the student's number that corresponds to his/her grade level matches the range of grades that an available teacher is qualified to teach. Based upon the result of the comparison 350, the system may adjust 355 an initial queue score related to grade accordingly for the student. Similar to the examples described above, the longer a student waits in the queue before being picked up, the higher the student scores for teachers that are not a grade match. For example, the system may include 25 teachers who teach students in 1^{st} grade through 5^{th} grade, 25 teachers who teach students in 6^{th} grade through 8^{th} grade, 25 teachers who teach students in 9^{th} grade through 12^{th} grade, and 25 teachers who teach students in college-level courses. When a student in 11^{th} grade joins the queue, the student would score highest (the queue priority) for the teachers who teach 9^{th} through 12^{th} grade. As the student's wait time increases, the student becomes a higher match for all teachers, and thus is more likely to be scored higher for initial queue score for grade even for an available teacher that is not associated with an appropriate grade range. Accordingly, the end result is that students receive the best match for them while at the same time minimizing the student's wait time in the queue.

The system may further determine 360 whether the student has an assigned priority adjustment flag. The priority adjustment flag may provide the student with a higher priority in the queue if, for example, the student is completing a time-sensitive task. Thus, for example, if the student is in the middle of a timed test and needs an instructor's assistance, the student may receive a priority adjustment flag to ensure the student is at or near the top (or front) of the queue. Based upon the determination 360, the system may adjust 365 the student's associated initial queue score for priority adjustment flags.

Similarly, the system may determine 370 whether the student has an assigned additional assistance flag. The additional assistance flag may indicate that the student has an associated special need. For example, the additional assistance flag may provide an indication that the student is enrolled in a special or remedial education program, participates in an advanced or gifted learning program, or has some other similar reason for being flagged as requiring additional assistance. Thus, if a teacher that is qualified for handling students in a remedial program is available, a student requiring additional assistance may be flagged and prioritized accordingly. Like the above scenarios, based upon the determination 370, the system may adjust 375 the student's associated queue score for additional assistance flags.

An overall queue score may be determined 380 for the student based on the various initial queue scores related to, for example, subject, language, grade level, priority adjustment and additional assistance flags as described above. Each individual initial queue score may be a numerical value associated with each specific parameter such that a higher numerical value results in a higher queue priority for a particular student. Similarly, the overall queue score may be a summation of the individual queue scores. Thus, a higher overall queue score may indicate that a student scored high in each individual initial queue score. Alternatively, a binary scoring system may be used for each individual initial queue score. If a student matches an available teacher for a particular parameter, e.g., language, the initial queue score for that parameter may be set to 1. Otherwise, the initial queue score for that parameter may remain zero. Thus, a student with a score of five, when there were five parameters compared or determined as shown in the example illustrated in FIG. 3, would rank highest in priority because the student matched the available teacher in each parameter. In the event of multiple students having the same overall queue score, another factor such as total time in queue may be used as a tiebreaker.

For example, a teacher may have the following associated parameter values: math as the subject taught, a primary language of Spanish, and a grade level range of 3^{rd} grade through 8^{th} grade. In a theoretical case where the queue has three students who are requesting math teaching, a student that speaks Spanish and is in grade level 6 would score only behind students who also have primary language Spanish and a grade level between 3^{rd} grade and 8^{th} grade but who have been in the queue for a longer period of time, for a particular teacher with a matching language and grade level. As students wait in the queue, grade level and language match values trend toward zero. Accordingly, the students who are in the queue for the longest time period are most likely to be picked up by the first available teacher, thereby minimizing overall wait times. In some embodiments, the score may be based on other factors not specifically described herein.

Additionally, each individual initial queue score may have an associated weight when determining the overall queue score. For example, the initial queue score for each parameter may have an equal weight, e.g., 20% when there are five parameters such as the example above as illustrated in FIG. 3. However, based upon the implementation of the system and processes described herein, one or more parameters may have a unique weight when determining the overall queue score. For example, with the five parameters as described above (i.e., language, subject, grade, priority adjustment flag and additional assistance flag), the initial queue score for language may contribute 40% to the overall queue score, while the remaining four parameters may each contribute 15%. Thus, an administrator or other supervisor of the assistance providing system may control which parameters are considered more important than others when matching a student and a teacher.

The system may adjust 385 the queue priority for the student based upon the score. If the student does not match an available teacher, some or all of the process as described herein may be repeated until each student in the queue has been matched with an available teacher or there are no additional teachers available (e.g., the working hours associated with the assistance system have elapsed).

Those having ordinary skill in the art will recognize that the processes described with respect to FIG. 3 may be repeated as necessary for each user in the queue. Thus, users may move up or down in the queue depending on the priority determination for other users that join the queue and/or as users leave the queue. Accordingly, the queue may dynamically change as students enter and leave. Additionally, it should be noted that the process order as described with respect to FIG. 3 is by way of example only and is shown as an illustrative example of one sample method for optimizing the queue according to the techniques as taught herein. Various of the process steps, such as the comparison steps 330, 340 and 350 for example, may be done in any order or, if so implemented, simultaneously.

FIG. 4 depicts a block diagram of illustrative internal hardware that may be used to contain or implement program instructions, such as the process steps discussed herein, according to various embodiments. A bus 400 may serve as the main information highway interconnecting the other illustrated components of the hardware. A CPU 405 is the central processing unit of the system, performing calculations and logic operations required to execute a program. The CPU 405, alone or in conjunction with one or more of the other elements disclosed in FIG. 4, is an illustrative processing device, computing device or processing device as such terms are used within this disclosure. Read only memory (ROM) 410 and random access memory (RAM) 415 constitute illustrative memory devices (such as, for example, processing device-readable non-transitory storage media).

A controller 420 interfaces with one or more optional memory devices 425 to the system bus 400. These memory devices 425 may include, for example, an external or internal DVD drive, a CD ROM drive, a hard drive, flash memory, a USB drive, or the like. As indicated previously, these various drives and controllers are optional devices.

Program instructions, software, or interactive modules for providing the interface and performing any querying or analysis associated with one or more data sets may be stored in the ROM 410 and/or the RAM 415. Optionally, the program instructions may be stored on a tangible computer-readable medium such as a compact disk, a digital disk, flash memory, a memory card, a USB drive, an optical disc storage medium, such as a Blu-Ray™ disc, and/or other non-transitory storage media.

An optional display interface 430 may permit information from the bus 400 to be displayed on the display 435 in audio, visual, graphic, or alphanumeric format, such as the interface previously described herein.

The hardware may also include a local interface 440 which allows for receipt of data from input devices such as a keyboard 445 or other input device 450 such as a mouse, a joystick, a touch screen, a remote control, a pointing device, a video input device and/or an audio input device.

The hardware may also include a storage device 460 such as, for example, a connected storage device, a server, and an offsite remote storage device. Illustrative offsite remote storage devices may include hard disk drives, optical drives, tape drives, cloud storage drives, and/or the like. The storage device 460 may be configured to store data as described herein, which may optionally be stored on a database 465. The database 465 may be configured to store information in such a manner that it can be indexed and searched, as described herein.

Communication with external devices, such as a print device or a remote computing device, may occur using various communication ports 470. An illustrative communication port 470 may be attached to a communications network, such as the Internet, an intranet, or the like. As shown in FIG. 4, a remote device may be operably connected to the communications port 470 via a remote interface 475. The remove device may include, for example, a display interface 480 with a connected display 485, an input device 490 and a keyboard 495.

The computing device of FIG. 4 and/or components thereof may be used to carry out the various processes as described herein.

### Example

Many students may be concurrently logged in through an application website for educational activities at any time. When a student requests live teaching support, the system places their request in a waiting queue for teacher assistance. The teachers can select a student from the queue to provide personal teaching. An algorithm that is used to determine which student should be at the front of the queue considers several factors: time_in_queue, language_preference, grade_level, subject, and priority_adjustment

The algorithm first assesses the difference between the current time and the time at which the student entered the queue. It then assesses three independent variables; each variable will either be a match between student and teacher or not a match. The three variables are grade level, subject, and primary language preference. Grade level is stored as a number on the student's profile. Live teachers have a grade level range in their profile that lists the grade levels they are best able to teach. Subject is defined by the material the student is accessing at the time the student requests help from a teacher. Teachers may have multiple subjects listed on their profile.

The system first excludes teachers whose subjects do not match the subject of the student's request. The grade level and language preference matches are weighted rather than exclusionary, since a teacher who does not speak the student's primary language or is not a specialist in math at the student's grade level can still be helpful to the student. The impact of these attributes on the algorithm is calculated by taking the grade_level or language_preference match, expressed as a Boolean, and subtracting the wait time. To illustrate, the formula for language_impact looks like:

language_impact=round(max(0,language_preference−time_in_queue)*1.1)

In this fashion, as students wait longer, they will have an increasing priority for teachers whose language_preference does not match in order to minimize the overall wait time for these students. The impact of grade_level preference operates similarly. Lastly, a priority_adjustment flag and an additional_assistance flag are included based on a setting stored for the student, to allow for testing or other cases where a particular student may need to be immediately advanced to the top of the queue or paired with a specifically qualified teacher.

The final, full algorithm adds the additional metrics:

score=subject_match*(time_in_queue+language_impact+grade_level_impact+priority_adjustment+additional_assistance)

The queuing mechanism re-assesses all students against the algorithm and re-ranks them whenever a student is added or removed from the queue. A sample data structure for the student rankings might look like this:
[{student: { . . . }, score: 10},
{student: { . . . }, score: 3},
{student: { . . . }, score: 1}]

The platform then connects the top-ranked student in the list to the requesting teacher.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method comprising:
providing, by a processing device, at least one educational curriculum module to a plurality of user devices, each of which is associated with one of a plurality of users;
establishing, by the processing device, at least one learning interface with each of the plurality of user devices through the at least one educational curriculum module, the at least one learning interface comprising remote access to subject specific lessons, coursework and quizzes;
receiving, by the processing device, a request for live support from at least one first user accessing the at least one learning interface, the first user having first user information associated with the first user's current interaction with the at least one learning interface prior to submitting the request for live support;
placing, by the processing device, the at least one first user in a queue;
determining, by the processing device, a plurality of parameters for the at least one first user, wherein at least a portion of the plurality of parameters comprises the first user information;
optimizing, by the processing device, the queue, wherein the optimizing comprises iteratively assigning and updating a queue priority level for each user in the queue, wherein the queue priority level indicates a location in the queue at which a user in the queue is currently placed;
if the at least one first user is at the front of the queue:
matching, by the processing device, at least one second user to the at least one first user, and
establishing, by the processing device, a communication session between the at least one first user and the at least one second user, wherein the at least one second user is provided with the first user information; and
if the at least one first user is not at the front of the queue, updating the queue priority level for the at least one first user.

2. (canceled)

3. The method of claim 1, wherein establishing at least one learning interface comprises providing a discussion tool to facilitate communication between the matched at least one first user and the matched at least one second user.

4. The method of claim 3, wherein the communication between the matched at least one first user and the matched at least one second user is facilitated via at least one of a voice-based communication session, a text-based communication session, and a video-based communication session.

5. The method of claim 1, further comprising:
establishing an operable connection, by the processing device, between a first user device associated with the at least one first user and a second user device associated with the at least one second user.

6. The method of claim 1, wherein optimizing the queue comprises:
for each first user:
determining, by the processing device, a current wait time,
determining, by the processing device, a grade level, a subject, and a primary language preference of the first user, and
determining, by the processing device, at least one second user that is available; and
for each second user that is available:
determining, by the processing device, that one or more language, grade level expertise, and subject expertise of the second user do not match the grade level, the subject, and the primary language preference of the first user,
subtracting, by the processing device, a time from the current wait time to obtain an adjusted time, and
adjusting, by the processing device, the first user's queue priority level based on the adjusted time.

7. The method of claim 1, wherein optimizing the queue comprises:
for each first user:
determining, by the processing device, a current wait time,
determining, by the processing device, a grade level, a subject, and a primary language preference of the first user, and
determining, by the processing device, at least one second user that is available; and
for each second user that is available:
determining, by the processing device, that language, grade level expertise, and subject expertise of the second user match the grade level, the subject, and the primary language preference of the first user,
determining, by the processing device, the first user's wait score, and
adjusting, by the processing device, the first user's queue priority level based on the wait score.

8. The method of claim 1, wherein the at least one first user is a student.

9. The method of claim 1, wherein the at least one second user is a teacher or a tutor.

10. A system comprising:
a processing device; and
a non-transitory, computer-readable storage medium in operable communication with the processing device, wherein the non-transitory, computer-readable storage medium comprises one or more programming instructions that, when executed, cause the processing device to:
provide at least one educational curriculum module to a plurality of user devices, each of which is associated with one of a plurality of users,
establish at least one learning interface with each of the plurality of user devices through the at least one educational curriculum module, the at least one learning interface comprising remote access to subject specific lessons, coursework and quizzes,
receive a request for live support from at least one first user accessing the at least one learning interface, the first user having first user information associated with the first user's current interaction with the at least one learning interface prior to submitting the request for live support,
place the at least one first user in a queue,
determine a plurality of parameters for the at least one first user, wherein at least a portion of the plurality of parameters comprises the first user information,
optimize the queue, wherein the optimizing comprises iteratively assigning and updating a queue priority level for each user in the queue, wherein the queue priority level indicates a location in the queue at which a user in the queue is currently placed,
if the at least one first user is at the front of the queue;
match at least one second user to the at least one first user, and
establish a communication session between the at least one first user and the at least one second user, wherein the at least one second user is provided with the first user information, and
if the at least one first user is not at the front of the queue, update the queue priority level for the at least one first user.

11. (canceled)

12. The system of claim 10, wherein the one or more programming instructions that, when executed, cause the processing device to establish the at least one learning interface session further comprise one or more additional programming instructions that, when executed, cause the processing device to:
provide a discussion tool to facilitate communication between the matched at least one first user and the matched at least one second user.

13. The system of claim 12, wherein the communication between the matched at least one first user and the matched at least one second user is facilitated via at least one of a voice-based communication session, a text-based communication session, and a video-based communication session.

14. The system of claim 10, wherein the non-transitory, computer-readable storage medium further comprises one or more programming instructions that, when executed, cause the processing device to:
establish an operable connection between a first user device associated with the at least one first user and a second user device associated with the at least one second user.

15. The system of claim 10, wherein the one or more programming instructions that, when executed, cause the processing device to optimize the queue comprises one or more programming instructions that, when executed, cause the processing device to:
for each first user:
determine a current wait time,
determine a grade level, a subject, and a primary language preference of the first user, and
determine at least one second user that is available, and
for each second user that is available:
determine that one or more of language, grade level expertise, and subject expertise of the second user do not match the grade level, the subject, and the primary language preference of the first user,
determine a time from the current wait time to obtain an adjusted time, and
adjust the first user's queue priority level based on the adjusted time.

16. The system of claim 10, wherein the one or more programming instructions that, when executed, cause the processing device to optimize the queue comprises one or more programming instructions that, when executed, cause the processing device to:
determine a current wait time;
determine a grade level, a subject, and a primary language preference of the first user;
determine at least one second user that is available; and
for each second user that is available:
determine that language, grade level expertise, and subject expertise of the second user match the grade_level, the subject, and the primary language preference of the first user,
determine the first user's wait score, and
adjust the first user's queue priority level based on the wait score.

17. The system of claim 10, wherein the at least one first user is a student.

18. The system of claim 10, wherein the at least one second user is a teacher or a tutor.
